(19) United States
(12) Patent Application Publication
(10) Pub. No.: US 2012/0128569 A1
(43) Pub. Date: May 24, 2012

(54) DESTRUCTION OF AMMONIUM IONS

(76) Inventors: Hendrik Oevering, Beek (NL); Rudolf Philippus Maria Guil, Maastricht (NL); Carlos Lopez Cruz, Maastricht (NL); Theodorus Friederich Maria Riesthuis, Obbicht (NL)

(21) Appl. No.: 13/122,573

(22) PCT Filed: Oct. 7, 2009
(86) PCT No.: PCT/EP09/63023

§ 371 Date: Jun. 20, 2011

(30) Foreign Application Priority Data
Oct. 10, 2008 (EP) 08017782.7
Oct. 10, 2008 (EP) 08017783.5

(51) Int. Cl. C01B 21/02; B01J 7/02

(52) U.S. Cl. 423/351; 422/187

(57) ABSTRACT

The invention relates to a process for converting ammonium formed in a hydroxylamine phosphate oxime process into molecular nitrogen in an ammonium destruction zone, comprising—preparing a vapour stream comprising nitrogen oxide from ammonia, in an ammonia combustion zone;—bringing into contact by feeding to the ammonium destruction zone, individually and/or as pre-mixed combinations, at least part of said vapour stream, and a first liquid stream, comprising ammonium formed in the hydroxylamine phosphate oxime process, and a second liquid stream, comprising at least one acid selected from nitric acid and nitrous acid in a total nitric+nitrous acid concentration of at least 30 wt. %, thereby forming in the ammonium destruction zone a fluid mixture; and—reacting ammonium ions in the fluid mixture with nitrogen oxide under formation of molecular nitrogen, in the ammonium destruction zone. The invention further relates to an installation for converting ammonium formed in a hydroxylamine phosphate oxime process.

The invention relates to a process for converting ammonium ions (which may herein after be referred to as ‘ammonium’) from a hydroxylamine phosphate oxime process (HPO process) for the production of cyclohexanone oxime into molecular nitrogen. Further, the invention relates to an installation for carrying out such a process.

GB 1 287 303 describes an HPO process wherein nitrate is catalytically reduced into hydroxylamine, but wherein also ammonium is formed as an undesired side-product. Ammonium, present in the process liquid of the HPO process, is removed by reacting it with a nitrogen oxides vapour (nitrous gases) under formation of molecular nitrogen. The removal is typically carried out at a temperature of 80° C. or less. The nitrogen oxides vapour is typically obtained from a process for preparing nitric acid by oxidising ammonia. The vapour is then led through a condenser wherein part of the vapour is condensed to form a liquid comprising nitric acid, typically an aqueous solution comprising less than 30 wt. % nitric acid, and the remainder of vapour is partly used to remove the ammonium present in the liquid process stream of the HPO process, and partly to make an additional amount of nitric acid.

According to U.S. Pat. No. 5,364,609, the process of GB 1 287 303 is disadvantageous in that it has a small capacity, it needs a large investment in process equipment for preparing nitrogen oxides (and the nitric acid). Further, it is said to have a large environmental impact of the release of nitrogen oxides containing vapours. In the HPO process of U.S. Pat. No. 5,364,609, an aqueous acid reaction medium which contains ammonium ions is continuously circulated between an hydroxylammonium salt synthesis zone and an oxime synthesis zone. The process comprises
(i) continuously supplying nitrate ions or nitrogen oxides to be converted into nitrate by a nitrogen source to the aqueous acid reaction medium for formation of hydroxylammonium salt;
(ii) catalytically reducing the nitrate ions with molecular hydrogen to hydroxylamine, wherein ammonium ions are formed as a by-product in reduction of the nitrate ions;
(iii) removing the ammonium ions by reaction with nitrogen oxides;
(iv) contacting the aqueous acid reaction liquid with a gas flow containing nitrogen oxides generated in catalytic combustion of ammonia;
(v) converting ammonium ions into nitrogen utilising 0.01 to 5 wt. % of the nitrogen oxides from the said gas flow containing nitrogen oxides generated in the catalytic combustion of ammonia;
(vi) utilising remaining nitrogen oxides from the said nitrogen containing gas flow for preparation of nitric acid.

It is to be noted that, in another document, GB 1 287 302, also an HPO process is described wherein nitrate is catalytically reduced into hydroxylamine, in which ammonium ion destruction occurs in an ammonium destruction zone wherein the ammonium ion containing process liquid of the HPO process is directly contacted with nitrogen oxide containing gas produced in an ammonia combustion zone at a temperature of above 40° C., without any pre-condensation step of diluted nitric acid solution from this gas stream. The remaining gas stream from the ammonium ion destruction zone is then treated in a second absorption zone in which the remainder of the nitrogen oxide is absorbed as nitric acid in a liquid HPO process stream at a temperature below 40° C.

It is an object of the invention to provide a novel process for converting ammonium ions from an HPO process into molecular nitrogen (N₂).

It is a further object of the invention to provide a novel installation for carrying out a process for converting ammonium ions from an HPO process into molecular nitrogen.

It is in particular an object of the invention to provide a process wherein the nitrogen oxide contacted with a liquid stream comprising ammonium ions (such as the aqueous liquid referred to above) is more effectively used for destruction of ammonium ions, than in a prior art process, e.g. as identified above.

One or more other objects which may be met in accordance with the invention will become apparent from the description and/or claims herein below.

The present invention relates to a process for converting ammonium ions formed in a hydroxylamine phosphate oxime process into molecular nitrogen in an ammonium destruction zone, comprising
—a—preparing a vapour stream comprising nitrogen oxide from ammonia, in an ammonia combustion zone;
—b—bringing into contact by feeding to the ammonium destruction zone, individually and/or as pre-mixed combinations,
   (i) at least part of the vapour stream prepared in —a—, and
   (ii) a first liquid stream comprising ammonium ions formed in the hydroxylamine phosphate oxime process, and
   (iii) a second liquid stream comprising at least one acid selected from nitric acid and nitrous acid in a total nitric+nitrous acid concentration of at least 30 wt. %, thereby forming in the ammonium destruction zone a fluid mixture; and
—c—reacting ammonium ions in the fluid mixture with nitrogen oxide under formation of molecular nitrogen, in the ammonium destruction zone.

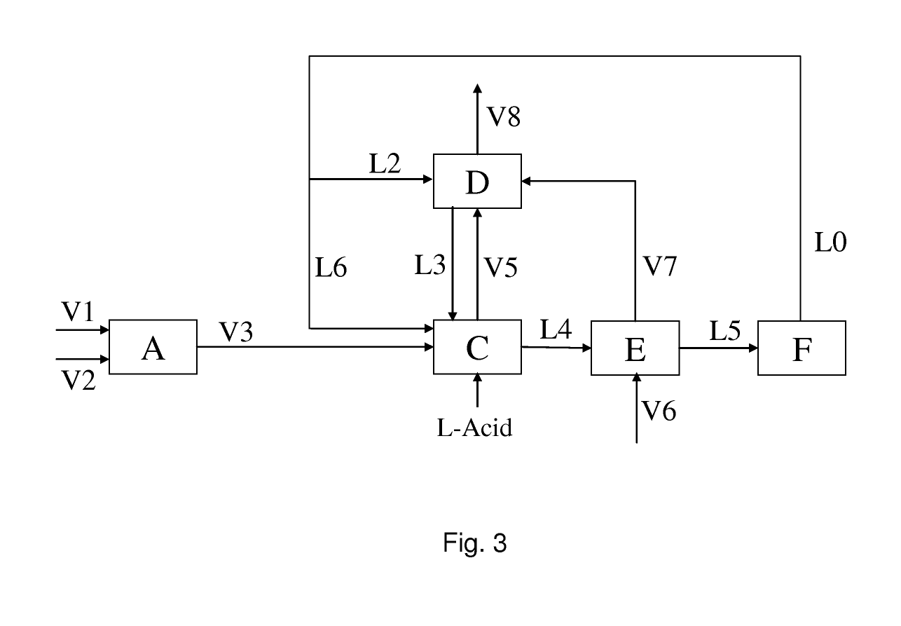

The present invention further relates to an installation (e.g. as shown in FIG. 3) for converting ammonium from a hydroxylamine phosphate oxime installation (F) into molecular nitrogen, the installation comprising

an ammonia combustion zone (A) for converting ammonia into nitrogen oxide, comprising an inlet for a stream comprising ammonia (V1), an inlet for a stream comprising oxygen (V2), and an outlet (V3) for a vapour stream comprising nitrogen oxide, which outlet is connected to an inlet for vapour stream of an ammonium destruction zone (C) via a conduit for leading the vapour stream comprising nitrogen oxide into the ammonium destruction zone (C), the ammonium destruction zone (C) comprising an inlet (L-Acid) for co-feeding liquid nitric acid and/or nitrous acid into the installation, an inlet for a liquid stream comprising ammonium (L3) which inlet is connected to an outlet of a nitrogen oxide absorption zone (D), optionally an inlet (L6) for leading a liquid stream comprising ammonium originating from a hydroxylamine phosphate oxime process (F) into the ammonium destruction zone (C), an outlet (V5) for a vapour stream comprising nitrogen oxide which outlet is connected to an inlet of the nitrogen oxide absorption zone (D), and an outlet (L4) for a liquid stream which outlet is connected to an inlet of a bleaching zone (E);
the nitrogen oxide absorption zone (D) comprising an inlet (L2) for leading a liquid stream comprising ammonium originating from a oxime synthesis zone of a hydroxylamine phosphate oxime production zone (F) into the nitrogen oxide absorption zone (D), an inlet (V7) for leading a stream comprising oxygen into the nitrogen oxide absorption zone (D), and an outlet (V8) for off-gas;
the bleaching zone (E) comprising an inlet (V6) for a vapour stream comprising oxygen (such as air, oxygen-enriched air or another mixture of oxygen and nitrogen), an outlet for vapour stream (V7) comprising oxygen connected to the inlet for leading vapour stream comprising oxygen into the nitrogen oxide absorption zone (D), and an outlet for a liquid stream (L5) comprising process liquid and nitric acid (formed in zones C, D), which outlet is connected to an inlet for a hydroxyl ammonium salt synthesis zone of the hydroxylamine phosphate oxime process (F).
Such installation is in particular suitable for destructing ammonium ions formed in a hydroxylamine phosphate oxime process.

The second liquid stream comprising nitric and/or nitrous acid will hereinafter also be referred to as a co-feed. With co-feed is meant, that the feed has not been produced in the process of the invention. More specifically, with a co-feed of liquid comprising nitric acid and/or nitrous acid is meant that the liquid comprises nitric acid and/or nitrous acid that has been produced in an external process for production of nitric acid and/or nitrous acid. Preferably the co-feed is an aqueous liquid, i.e. a liquid wherein water is the major (>50 wt. % of total liquids) or only solvent in the liquid, usually the only solvent of the liquid. For instance, for the co-feed commercially obtained nitric acid, commercially obtained nitrous acid or a mixture thereof may be used. In particular, as a co-feed, industrial grade nitric acid and/or nitrous acid may be used. Particularly good results have been achieved with an aqueous nitric acid solution.

Preferably, the total nitric and/or nitrous acid concentration of the co-feed is 35 wt. % or more, based on total weight. In a particularly preferred method an aqueous solution comprising in total 40 to 70 wt. % nitric acid and/or nitrous acid may be used. Preferably, the total nitric acid and/or nitrous acid concentration in the co-feed is at least 50 wt. %, in particular at least 55 wt. %, more in particular at least about 60 wt. %.

The co-feed may be introduced directly into an ammonium destruction zone, it may be combined with process liquid from the HPO process prior to entering the destruction zone, or it may be combined with vapour stream from combustion zone A prior to entering the destruction zone.

The inventors have realised that the use of a co-feed is advantageous in that the efficiency at which nitrogen oxide obtained in combustion zone A can be used for ammonium destruction can be increased.

As demonstrated by the examples, the effect of co-feeding a liquid stream comprising (concentrated) acid, originating from outside the ammonia combustion zone, results in the nitrogen oxide being used more effectively.

Further, it is envisaged that a process according to the invention allows production of oxime at an increased capacity, using the same amount of ammonia for combustion.

The term “or” as used herein means “and/or” unless specified otherwise.

The term “a” or “an” as used herein means “at least one” unless specified otherwise.

When referring to a noun (e.g. a compound, an additive, etc.) in singular, the plural is meant to be included.

When referring herein to “(a) nitrogen oxide(s)” (NOₓ) this is meant to include any oxide of nitrogen, and in particular NO and NO₂. When referring to NO and/or NO₂, this generally includes larger molecular forms of NO and/or NO₂, such as N₂O₃ (formed of one molecule NO and one molecule of NO₂), N₂O₄ (formed of two molecules of NO₂), and other nitrogen oxides at least conceptually consisting of a plurality of NO and/or NO₂ molecules, as is in line with common practice in the art.

The fluid mixture formed in the ammonium destruction zone typically comprises a liquid phase (generally formed of process liquid from the HPO process and liquid co-feed, wherein at least part of the vapour stream is dissolved), wherein ammonium destruction takes place. The fluid mixture may also comprise a vapour phase, comprising, next to nitrogen from ammonia combustion, for a small part nitrogen that has been formed in the destruction zone, and optionally undissolved nitrogen oxide vapour.

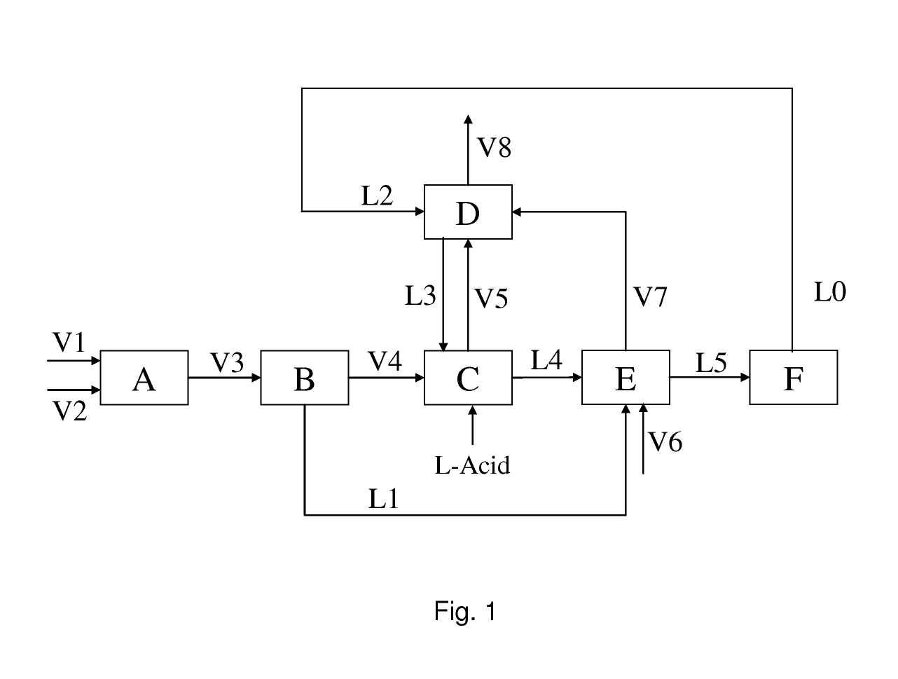

FIG. 1 schematically shows an embodiment of the invention.

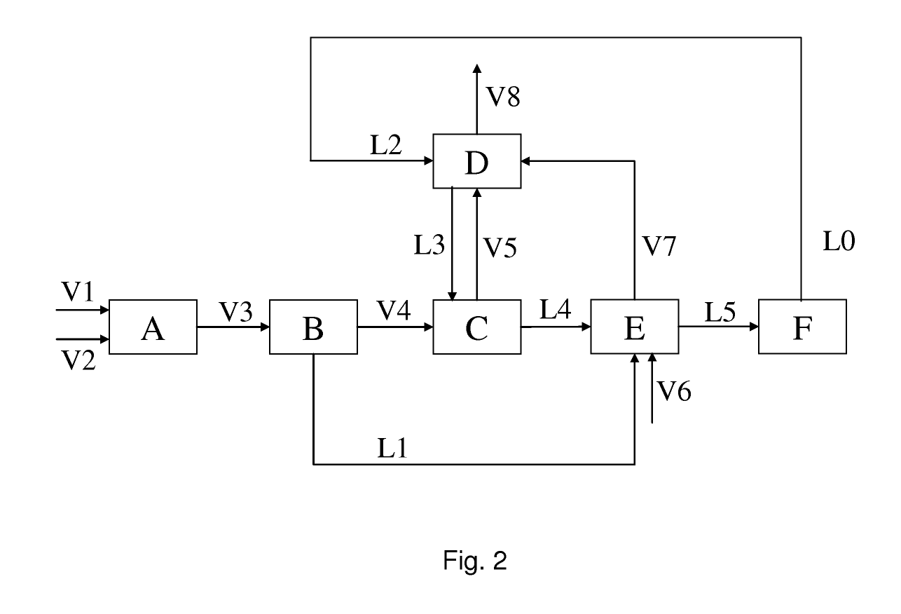

FIG. 2 schematically shows a reference process. Compared to the embodiment of the invention as depicted in FIG. 1, no co-feed for liquid nitric/nitrous acid is present.

FIG. 3 schematically shows an embodiment of the invention without a condenser for vapour stream between the ammonia combustion zone A and the ammonium destruction zone C.

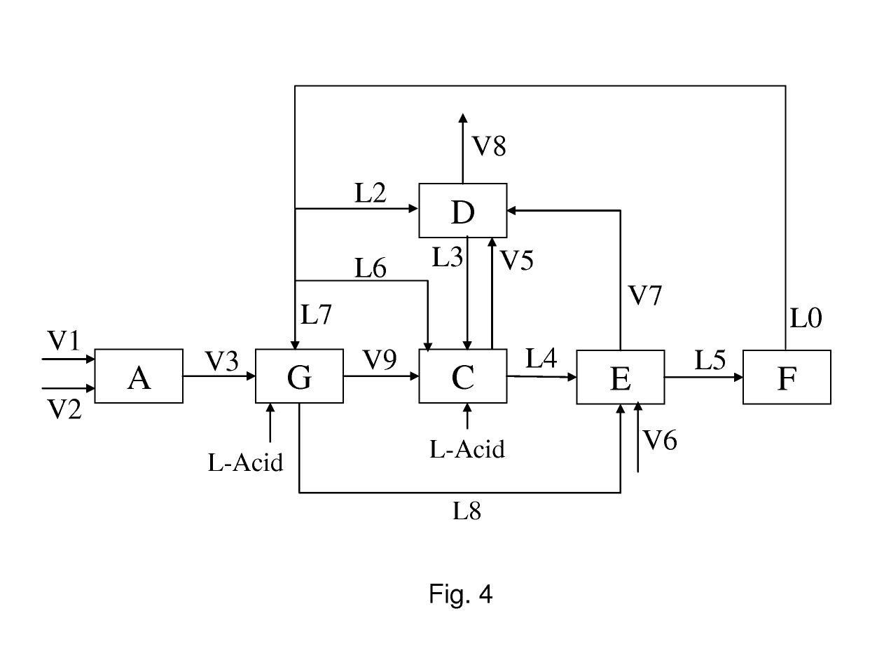

FIG. 4 schematically shows an embodiment of the invention with an additional ammonium destruction zone G.

Without being bound by theory, it is contemplated that the co-feed advantageous effect is at least partly due to an increase in H⁺ concentration of the liquid phase in the ammonium destruction zone. The co-feed feed rate is usually chosen to provide an H⁺ concentration in the liquid phase in the ammonium destruction zone into which the co-feed is fed to provide a H⁺ concentration of more than 3 mol/kg liquid phase, preferably to provide a H⁺ concentration of at least 5 mol/kg liquid phase, more preferably to provide a H⁺ concentration of at least 6 mol/kg liquid phase. In a particularly preferred method the feed rate is sufficient to provide an H⁺ concentration of at least 7 mol/kg liquid phase.

In an embodiment of the invention wherein an acid co-feed is used, the co-feed feed rate is usually chosen to provide an H⁺ concentration in the liquid phase in the ammonium destruction zone into which the co-feed is fed of 10 mol/kg liquid phase or less, preferably to provide a H⁺ concentration of 9 mol/kg liquid phase, or less. In a particularly preferred method the feed rate is chosen to provide an H⁺ concentration of 8 mol/kg liquid phase or less.

As used herein, the total H⁺ concentration, is the concentration as can be measured by titration to a pH of 4.2. Preferably, said titration is performed by adding 5 ml of a sample of liquid phase (taken from the ammonium destruction zone) to 50 ml distilled water and performing titration with a 0.25 N NaOH solution to a pH of 4.2. The skilled person will be able to determine a suitable co-feed feed rate to achieve this, based on common general knowledge, the information disclosed herein and optionally a limited amount of routine testing.

The order wherein the (at least part of the) vapour stream, the first liquid stream and the second liquid stream are brought into contact by feeding, and where in the process the initial contact takes place can be chosen as desired. This can suitably be done by premixing of the two liquid streams, or by premixing of the second liquid stream and the vapour stream before they are introduced into the ammonium destruction zone. Alternatively all streams may individually be introduced into the ammonium destruction zone. In particular suitable is a method wherein the vapour stream in as far as it is to be brought into contact with the first and the second liquid stream is introduced into the ammonium destruction zone and brought into contact with the first and the second liquid stream in the ammonium destruction zone. However, premixing of the vapour stream and the first liquid stream is less advantageous.

Preferably a large part of the vapour stream (as prepared in —a—) is fed to the ammonium destruction zone, most preferably all of said vapour stream is fed thereto. In a preferred embodiment, the vapour stream that is fed to the ammonium destruction zone is brought into contact with the first and the second liquid stream in the ammonium destruction zone.

As illustrated by FIG. 1, in accordance with the invention ammonium is removed from a liquid process stream from a HPO installation F, the liquid leaving installation F via conduit LO. Installation F may in principle be any installation for preparing cyclohexanone oxime. Such installations are generally known in the art. The removal of ammonium comprises a reaction of the ammonium with nitrogen oxide, wherein nitrogen oxide first has dissolved in the liquid. As a reaction product molecular nitrogen is formed. This reaction may be referred to as ammonium destruction.

Nitrogen oxide for destructing ammonium is prepared in an ammonia combustion zone A for converting ammonia into nitrogen oxide. Suitable combustion zones are known in the art.

The relative molar concentration of NO₂, based on total concentration NO+NO₂ (100%*[NO₂]/{[NO]+[NO₂]}), counting an N₂O₃ molecule as one NO molecule and one NO₂ molecule, and counting N₂O₄ as two NO₂ molecules, in the vapour stream comprising nitrogen oxide fed into the ammonium destruction zone with the liquid stream comprising ammonium is preferably at least 30%, in particular at least 40%, preferably in the range of 40 to 90%, more in particular at least 50%, preferably in the range of 50 to 80%, most preferably at least 55%. Usually more than 95 mol % of the total nitrogen oxide, in particular more than 98 mol % is formed by NO, NO₂, N₂O₃, and N₂O₄.

The skilled person will know how to achieve such ratio based on common general knowledge, and the present description. In practice, the relative molar concentration of NO₂ will generally be less than 100%. In particular, the relative molar concentration of NO₂ may be 90% or less, more in particular 80% or less. In particular, if desired, this ratio may be adjusted by adjusting the temperature and/or residence time and/or pressure of the nitrogen oxide containing vapour stream obtained from ammonia combustion zone A, in the part of the installation between the ammonia combustion zone A and ammonium destruction zone C.

As illustrated in FIG. 1, in a process of the invention a stream comprising ammonia V1 and a stream comprising oxygen V2, e.g. air or oxygen enriched air, can be led into ammonia combustion zone A, wherein nitrogen oxide is formed.

In the embodiment shown in FIG. 1, the vapour stream comprising nitrogen oxide leaving the ammonia combustion zone (via V3) is led through a nitric and/or nitrous acid production zone represented by zone B. In general, such zone comprises a condenser. In zone B part of the vapour stream is condensed to form a further liquid stream, comprising nitric acid and/or nitrous acid, which may be led into bleaching zone E via conduit L1. The remainder of the vapour stream is to be led into the ammonium destruction zone C via conduit V4. The liquid formed in zone B typically comprises nitric acid and/or nitrous acid in a total concentration of less than 30 wt. %.

Although not shown in FIG. 1, an installation for carrying out a method of the invention may be provided with one or more zones for adjusting the relative molar concentration of NO₂ of the vapour stream. For instance one or more zones for increasing residence time, such as one or more vessels, and/or one or more heat-exchangers (other than condensers) may be present in between zone A and zone C to adjust vapour stream.

The conduit for vapour stream V4 out of zone B is arranged to lead remaining vapour stream originating from the ammonia combustion zone A to the ammonium destruction zone C.

In the embodiment shown in FIG. 1 conduit V4 is connected to an inlet of ammonium destruction zone C. In principle, the temperature may be about the temperature of the vapour when exiting the combustion zone A, although, normally, the temperature will be lower (due to energy recovery). In particular in zone B the vapour will generally be cooled, typically to a temperature of 70° C. or less.

The temperature of the liquid phase in the destruction zone C (comprising process liquid from HPO installation F wherein at least part of the nitrogen oxide from the vapour has been dissolved mixed with the nitric acid and/or nitrous acid co-feed) can be chosen within wide limits. Usually, said temperature is 50° C. or more, in particular at least 60° C., more in particular at least 65° C. or at least 70° C. Surprisingly, the inventors have found that the ammonium destruction selectivity can be further increased by carrying out the destruction at a higher temperature, e.g. at a temperature of at least 80° C., or at least 90° C. It is noted that at increasing temperature, the risk of corrosion of the inner walls of the destruction zone may increase. Such risk may be reduced by using a destruction zone of which the inner walls are made of a material that is highly corrosion resistive, or has been provided with an protective coating. Such materials are known in the art. Inter alia, in view of a potential risk of unacceptable corrosion, the temperature is usually 180° C. or less, preferably 150° C. or less, in particular 130° C. or less, more in particular 110° C. or less.

As illustrated by FIG. 3, part of the process liquid stream from HPO process F may be directly led into destruction zone C (via L6) and part may be led into nitrogen oxide absorption zone D (via L2), where the liquid serves as medium to absorb nitrogen oxide in the vapour V5 that has left destruction zone C undissolved in the liquid phase. The vapour treated in absorption zone D (in general mainly nitrogen) can be discarded as off-gas (via V8). It is observed that in principle it is also possible to lead all process liquid from HPO installation F into the absorption zone. Preferably, the part of the process liquid led into the absorption zone D is chosen such that it is just sufficient to remove nitrogen oxide from the vapour led into the absorption zone to a desired extent, whereas the remainder of the process liquid is led into the ammonium destruction zone. The absorption zone is usually operated at a lower temperature than the destruction zone and also at a lower temperature than the feed process liquid from HPO process (F). For maintaining a high cooling capacity in absorption zone D for efficient nitrogen oxide(s) removal in the off-gas and for more efficient cooling of the overall ammonium containing feed liquid from HPO process (F) it is favourable to lead a large part of the HPO process liquid directly into destruction zone (C), which operates at a relatively high temperature and already is equipped with a internal or external cooler to cool away the reaction heat of the ammonium destruction reaction and control the temperature in destruction zone C at the desired level. Suitable ratios can be determined based on common general knowledge, the information disclosed herein and optionally some routine testing.

Conditions in absorption zone D can be as known in the art. In absorption zone D liquid stream L2 comprising ammonium originating from a oxime synthesis zone of a hydroxylamine phosphate oxime production zone (F) is used to absorb nitrogen oxide from the vapour stream V5 leaving the destruction zone C. A vapour stream V7 comprising oxygen (such as air or oxygen-enriched air) may be led into the nitrogen oxide absorption zone D to oxidise NO, thereby forming NO₂, which dissolves better in the process liquid. A stream V7 comprising oxygen, the remainder of a vapour stream V6 comprising oxygen that has been led through bleaching zone E, which streams also will contain N₂, may in particular be used.

In bleaching zone E part of the oxygen in the stream has been used to oxidise NO (generally as HNO₂/NO₂⁻ dissolved in process liquid), which may be present in the liquid stream (L4) leaving destruction zone C. Suitable conditions in bleaching zone E may be based on conditions known in the art.

As illustrated in FIGS. 3 and 4, the vapour stream V3 can be directly connected to the inlet of an ammonium destruction zone C, without first being led through a nitric acid and/or nitrous acid production zone B. Of course, The embodiment of FIG. 1 may be combined with the embodiment of FIG. 4, such that both a separate nitric/nitrous acid production zone B (in particular a condenser) is present, as well as at least two ammonium destruction zones (C, G).

In the embodiment illustrated by FIG. 3, the conduit for vapour stream V3 is arranged to lead vapour stream from the ammonia combustion zone A to the ammonium destruction zone C without passing through a separate nitric acid production zone B.

The inventors have found that it is possible to intensify the process of converting ammonium formed in an HPO process by omitting a separate nitric and/or nitrous acid formation zone B (such as a condenser) wherein nitric acid and/or nitrous acid is produced in the absence of process liquid from the HPO process, between ammonia combustion zone A and ammonium destruction zone C. Such process is in particular intensified in that more of the nitrogen oxide is available for destruction of ammonium than in a process wherein a nitric acid formation zone B is used. Thus, in accordance with this embodiment of the invention it is possible to contact the vapour stream comprising nitrogen oxide (leaving the ammonia combustion zone A) integrally with the liquid stream comprising the ammonium that is to be converted (in ammonium destruction zone C), instead of first converting a significant part of the available nitrogen oxide into nitric acid (aqueous solution), whilst maintaining a satisfactory ammonium conversion capacity, or even improving the ammonium conversion capacity.

It has in particular been found that by using a high fraction (compared to the above prior art processes) of the vapour stream obtained from combustion zone A or all of the combustion product(s) formed in zone A for conversion of ammonium in the liquid stream from the HPO process F (without prior conversion of nitrogen oxide into liquid nitric acid in a separate nitrous and/or nitric acid production zone B), it is possible to provide a process with improved selectivity towards ammonium destruction.

The temperature of the (at least part of the) vapour stream entering the ammonium destruction zone—or the temperature of the vapour stream when contacted with liquid stream, if the vapour stream is contacted with liquid stream prior to entering the ammonium destruction zone—can be chosen within wide limits. The temperature is usually more than 30° C., in particular at least 40° C., more in particular in the range of 50-300° C., most preferably a temperature in the range of 60-250° C. In view of energy-consumption, it is preferred that the temperature is 300° C. or less, in particular 250° C. or less, more in particular 200° C. or less.

In an embodiment wherein the vapour stream is first led through a nitrous and/or nitric acid production zone B, as illustrated by FIG. 1, the temperature is usually relatively low, normally below 80° C., in particular 70° C. or less.

In an embodiment wherein nitrous and/or nitric acid production zone B is omitted, as illustrated by FIG. 3, the nitrogen oxide vapour V3 is brought into contact with process liquid stream from the HPO installation F in ammonium destruction zone C, whilst the vapour temperature has been maintained above the condensation temperature of the vapour until it is contacted with the liquid stream. In an embodiment of the invention wherein nitrous and/or nitric acid production zone B is omitted, the temperature of the vapour comprising nitrogen oxide, when brought into contact with the liquid stream comprising ammonium, is therefore usually relatively high, compared to the processes wherein a nitrous and/or nitric acid production zone is present. In principle, the temperature may be about the temperature of the vapour when exiting the combustion zone A, although, normally, the temperature will be lower (due to energy recovery). The temperature of the vapour when entering the combustion zone may in particular be at least 110° C., preferably at least 120° C., in particular at least 130° C., more in particular at least 140° C.

The reaction of ammonium with nitrogen oxide in the destruction zone is usually carried out at a temperature in the range of 50-180° C., in particular at a temperature in the range of 60-150° C., more in particular at a temperature in the range of 65-130° C., or at a temperature in the range of 70-110° C.

In an embodiment wherein zone B is omitted, the temperature of the liquid phase in the destruction zone C (comprising process liquid from HPO installation F wherein at least part of the nitrogen oxide from the vapour has been dissolved) is usually as indicated above, with the proviso that it is usually lower than the temperature of the vapour when entering the destruction zone C.

In a specific embodiment, the invention relates to a process wherein two or more ammonium destruction zones are used, respectively an installation comprising two or more ammonium destruction zones, wherein at least one of the ammonium destruction zones is provided with a liquid co-feed for nitric acid and/or nitrous acid.

The arrangement of the flows of the liquid comprising ammonium and the flows of the vapours comprising nitrogen oxide may be as desired. For instance said liquids and vapours may be contacted in full counter current flow.

In a specifically preferred embodiment, the ammonium destruction zones are positioned in parallel (providing cross-flow) with respect to the stream of the liquid comprising ammonium (L6, L7) and in series with respect to the stream of the vapour comprising nitrogen oxide (V3, V9). This is considered favourable with respect to the destruction efficacy. FIG. 4 shows such an embodiment, wherein an embodiment with two ammonium destruction zones are shown, namely a first ammonium destruction zone G and a further ammonium destruction zone C. In FIG. 4 both shown ammonium destruction zones comprise an inlet for co-feed (L-Acid), but in principle it suffices if at least one of the ammonium destruction zones comprises an inlet for co-feed (L-Acid)

In between one or more further destruction zones (not shown) may be present, which in general may have inlets and outlets as next described for destruction zone G. In such an embodiment nitrogen oxide vapour V3 is led into a first destruction zone G, fed with process liquid stream L7 from HPO installation F. The vapour V9 leaving destruction zone G is fed into the subsequent destruction zone, whereas liquid L8 leaving destruction zone G is fed into the bleaching zone E. The last destruction zone (‘last’ with respect to the stream comprising nitrogen oxide, i.e. C in FIG. 4) has an outlet for vapour leading to the absorption zone D and an outlet for liquid leading to bleaching zone E, as described above when discussing FIG. 1 or 3.

In an advantageous process of the invention the ammonium concentration in the liquid stream leaving the ammonium destruction is kept within a specific concentration range, which is advantageous for using nitrogen oxide for ammonium destruction with a high efficiency. Therefore, usually, the liquid stream (L4, L8) leaving the ammonium destruction zone contains some residual ammonium. In particular, the ammonium concentration may be at least 0.05 mol/kg liquid; preferably it is at least 0.1 mol/kg liquid. Of course, the ammonium concentration leaving the ammonium destruction zone is always lower than in the liquid entering into the ammonium destruction zone. The ammonium concentration at the entrance of the ammonium destruction zone is usually in the range of between 1.5 and 3.5 mol/kg liquid. Usually, the ammonium concentration in the liquid stream (L4, L8) leaving the ammonium destruction zone is 3.0 mol/kg liquid or less, preferably 2.0 mol/kg liquid or less, more preferably 1.5 mol/kg liquid or less. In a specifically preferred embodiment, the ammonium concentration in the liquid stream leaving the ammonium destruction zone (L4, L8) is in the range of 0.15-1.3 mol/kg liquid. In particular under such conditions it has been found possible to use nitrogen oxide at an efficiency of at least 30% (in particular at 70° C. or more), or at least 50% (in particular at 90° C. or more), the efficiency being calculated as the molar percentage of nitrogen oxide present in the product gas obtained from ammonia combustion zone A that is finally used for destruction of ammonium.

Accordingly, the fluid mixture treated in the ammonium destruction zone is led out of the ammonium destruction zone as a liquid generally having an ammonium concentration of less than 3.0 mol ammonium per kg liquid, preferably 0.05-2.0 mol ammonium per kg liquid, in particular 0.1-1.5 mol ammonium per kg liquid, more in particular having 0.15-1.3 mol ammonium per kg liquid, with the proviso that the ammonium concentration in the first liquid stream before treatment in the destruction zone is higher than the ammonium concentration in the liquid led out of the destruction zone.

The ammonium concentration in the liquid stream leaving the ammonium destruction zone can be adjusted in a number of ways.

In an advantageous embodiment, the flow rate of the liquid stream comprising ammonium from the HPO (L0) process is controlled, based on the ammonium concentration in said liquid stream (L4, L8). By increasing the flow rate (under otherwise the same conditions), the ammonium concentration in the stream leaving the destruction zone typically increases, by decreasing the flow rate, the ammonium concentration in the stream leaving the destruction zone typically decreases. In a particularly preferred embodiment, the liquid stream from the HPO process is taken from an internal process liquid recycle stream in the HPO process (as is commonly present). Process stream LO from HPO process (F) sent to absorption zone D and destruction zone C (G) is, in general, a relatively small side-stream from a larger recycle stream within HPO process (F). After nitrogen oxide absorption, ammonium destruction and bleaching (zone E) the remaining liquid streams are sent back to said larger recycle stream. Thus by varying process stream LO the overall amount of recycle within HPO process (F) will not significantly change.

In a further embodiment, the feed rate of nitrogen oxide is increased to decrease the ammonium concentration (or vice versa). Further, increasing the temperature in the destruction zone may result in a decreased ammonium concentration in the liquid stream leaving the destruction zone, whereas decreasing the temperature in the destruction zone may resulting an increased ammonium concentration in said liquid stream.

The invention will now be illustrated by the following examples and comparative experiments.

### Comparative Experiment A: Effect Nitrogen Relative Molar Concentration of NO₂

A nitrogen oxide vapour feed stream and a liquid feed stream, containing ammonium, were continuously fed to a 150 ml continuously stirred tank reactor. The gas feed was introduced via a dip-pipe and thoroughly mixed by a self impelling stirrer at 1000 RPM stirring speed. The temperature in this ammonium destruction reactor was controlled at 70° C. and the reactor pressure was held at 6 bar. The effective amount of liquid present in the reactor was controlled at approx. 70 ml. The liquid feed, fed at a rate of 0.06 l/hr, was an aqueous solution containing approximately 2.5 mol/kg NH₄⁺, 0.8 mol/kg NO₃⁻, 3.8 mol/kg H₂PO₄⁻ and 2.1 mol/kg H⁺. The vapour feed was fed at 150° C. at a rate of 27 normal-litre/hr and contained 7.4 mol % NO and NO₂, in helium.

Liquid samples were taken directly from the reactor and analysed off-line by ion chromatography (NH₄⁺, NO₃⁻H₂PO₄⁻) while the components in the reactor off-gas, including N₂ as the product of the NH₄⁺ destruction reaction, were analysed on-line by gas chromatography.

The experiment was carried out for different relative molar concentrations of NO₂ in the gas feed (said molar concentration being calculated as 100*mol % NO₂/(mol % NO+mol %/NO₂). At a relative molar concentration of NO₂ of 20, 50, 70 and 90% the amount of nitrogen oxide that was effectively used for NH₄⁺ destruction to N₂ was respectively 12.9, 30.9, 38.0 and 36.9% of the amount of NO+NO₂ present in the feed gas. The major part of the rest of the NO+NO₂ was converted into HNO₃.

### Comparative Experiment B: Effect of Temperature

Comparative experiment B was performed in the same way as described in Comparative experiment A with the following differences. In this Comparative experiment, the vapour feed rate was 58 normal l/hr and consisted of 86.2 vol % Helium, 9.7 vol % NO₂ and 4.1 vol % NO. The liquid composition was the same as in Comparative experiment A, but in this example the feed rate was increased to 0.078 liter/hr. The experiment was performed at an ammonium destruction reactor temperature controlled at temperatures 70, 85, 95 and 110° C., respectively. At those temperatures the amount of nitrogen oxide that was effectively used for NH₄⁺ destruction to N₂ was respectively 33.9, 46.7, 56.6 and 58.4% of the amount of NO+NO₂ present in the feed gas. The major part of the rest of the NO+NO₂ was converted into HNO₃.

### EXAMPLE 1

### Effect of Co-Feeding a Concentrated Aqueous HNO₃ Solution and Comparative Experiment C

Experiments were performed in the same way as described in Comparative Example B at 70° C., with the difference that also various amounts of 65 wt % aqueous HNO₃ solution were co-fed to the ammonium destruction reactor. A comparative experiment (C) was carried out without a co-feed, and several experiments (Example 1) were carried out with a co-feed, namely of respectively 0.0078 or 0.0234 I/hr. The amount of nitrogen oxide that was effectively used for NH₄;⁺ destruction to N₂ was respectively 33.9 (no co-feed; Comparative experiment C), 45.4 (0.0078 l/hr co-feed) and 50.3% (0.0234 l/hr co-feed) of the amount of NO+NO₂ present in the feed gas. A large part of the rest of the NO+NO₂ was converted into HNO₃. The results are shown in table 1.

### EXAMPLE 2

### Effect of Temperature on Acidic Destruction

Experiments were performed as described in Example 1 with the following differences. 65 wt % HNO₃ feed was held at a constant addition rate of 0.0234 l/hr and the reaction temperature was controlled at three different values: 70° C., 85° C. and 95° C. At those temperatures the amount of nitrogen oxide that was effectively used for NH₄⁺ destruction to N₂ was respectively 50.3, 57.9 and 67.9 (mol %) of the amount of NO+NO₂ present in the feed gas. A large part of the rest of the NO+NO₂ was converted into HNO₃.

The effects of temperature on the NH₄⁺ destruction to N₂ without co-feed (not according to the invention), respectively with co-feed (at 0.0234 l/hr; according to the invention) are summarized in table 1 at the next page:

TABLE 1

| | Reaction T (° C.) | | | | | |
|---|---|---|---|---|---|---|
| | 70 | | 85 | | 95 | |
| | Comp. | Inv. | Comp. | Inv. | Comp. | Inv. |
| Co-feed (65 w %HNO₃ feed | 0 | 0.0234 | 0 | 0.0234 | 0 | 0.0234 |
| rate) [Liter/h]) | | | | | | |
| NH₄⁺ destruction via Pyria | 42.3 | 60.6 | 60.7 | 72.5 | 74.0 | 83.8 |
| reaction [mol %] | | | | | | |
| NOx efficiency [mol %] | 33.9 | 50.3 | 46.6 | 57.9 | 56.6 | 67.9 |
| Calculated NH₄⁺ destruction | 1.75 | 2.59 | 2.41 | 3.00 | 3.07 | 3.52 |
| rate [kmol/m³/hr] | | | | | | |

It can be concluded from table 1 that
a) ammonium ion destruction rate and NOₓ-efficiency increase with temperature;
b) with nitric acid co-feed the ammonium ion destruction rate and NOₓ-efficiency increase with temperature;
c) both ammonium ion destruction rate and NOₓ-efficiency increase significantly compared to the situation without such nitric acid co-feed.

1. Process for converting ammonium ions formed in a hydroxylamine phosphate oxime process into molecular nitrogen in an ammonium destruction zone, comprising
—a—preparing a vapour stream comprising nitrogen oxide from ammonia, in an ammonia combustion zone;
—b—bringing into contact by feeding to the ammonium destruction zone, individually and/or as pre-mixed combinations,
(i) at least part of the vapour stream prepared in —a—, and
(ii) a first liquid stream comprising ammonium ions formed in the hydroxylamine phosphate oxime process, and
(iii) a second liquid stream comprising at least one acid selected from nitric acid and nitrous acid in a total nitric+nitrous acid concentration of at least 30 wt. %, thereby forming in the ammonium destruction zone a fluid mixture; and
—c—reacting ammonium ions in the fluid mixture with nitrogen oxide under formation of molecular nitrogen, in the ammonium destruction zone.

2. Process according to claim 1, wherein all of said vapour stream prepared in —a— is fed to the ammonium destruction zone.

3. Process according to claim 1, wherein the vapour stream that is fed to the ammonium destruction zone is brought into contact with the first and the second liquid stream in the ammonium destruction zone.

4. Process according to claim 1, wherein the temperature of the at least part of the vapour stream comprising nitrogen oxide prepared in -a-, when brought into contact by the feeding in —b— with the second liquid and/or with the combined first liquid and the second liquid, has a temperature of at least 40° C., in particular a temperature in the range of 50-300° C., more in particular a temperature in the range of 60-250° C.

5. Process according to claim 1, wherein the reacting of ammonium with nitrogen oxide in the ammonium destruction zone is carried out at a temperature in the range of 50-180° C., in particular at a temperature in the range of 60-150° C., more in particular at a temperature in the range of 65-130° C., or at a temperature in the range of 70-110° C.

6. Process according to claim 1, wherein the fluid mixture treated in the ammonium destruction zone is led out of the ammonium destruction zone as a liquid having an ammonium concentration of less than 3.0 mol ammonium per kg liquid, preferably having 0.05-2.0 mol ammonium per kg liquid, in particular having 0.1-1.5 mol ammonium per kg liquid, more in particular having 0.15-1.3 mol ammonium per kg liquid, with the proviso that the ammonium concentration in the first liquid stream before treatment in the destruction zone is higher than the ammonium concentration in the liquid led out of the destruction zone.

7. Process according to claim 1, wherein the total nitric and/or nitrous acid concentration in the second liquid stream (iii) is at least 35 wt. % nitric and/or nitrous acid, preferably 40-70 wt. nitric and/or nitrous acid.

8. Process according to claim 1, wherein the relative molar concentration of NO₂, based on total of NO and NO₂ in the vapour stream comprising nitrogen oxide fed into the ammonium destruction zone with the liquid stream comprising ammonium is at least 30%, in particular in the range of 40 to 90%, more in particular in the range of 50 to 80%.

9. Installation for converting ammonium from a hydroxylamine phosphate oxime installation (F) into molecular nitrogen, the installation comprising
an ammonia combustion zone (A) for converting ammonia into nitrogen oxide, comprising an inlet for a stream comprising ammonia (V1), an inlet for a stream comprising oxygen (V2), and an outlet (V3) for a vapour stream comprising nitrogen oxide, which outlet is connected to an inlet for vapour stream of an ammonium destruction zone (C) via a conduit for leading the vapour stream comprising nitrogen oxide into the ammonium destruction zone (C), the ammonium destruction zone (C) comprising an inlet (L-Acid) for co-feeding liquid nitric acid and/or nitrous acid into the installation, an inlet for a liquid stream comprising ammonium (L3) which inlet is connected to an outlet of a nitrogen oxide absorption zone (D), optionally an inlet (L6) for leading a liquid stream comprising ammonium originating from a hydroxylamine phosphate oxime process (F) into the ammonium destruction zone (C), an outlet (V5) for a vapour stream comprising nitrogen oxide which outlet is connected to an inlet of the nitrogen oxide absorption zone (D), and an outlet (L4) for a liquid stream which outlet is connected to an inlet of a bleaching zone (E);
the nitrogen oxide absorption zone (D) comprising an inlet (L2) for leading a liquid stream comprising ammonium originating from a oxime synthesis zone of a hydroxylamine phosphate oxime production zone (F) into the nitrogen oxide absorption zone (D), an inlet (V7) for leading a stream comprising oxygen into the nitrogen oxide absorption zone (D), and an outlet (V8) for off-gas;
the bleaching zone (E) comprising an inlet (V6) for a vapour stream comprising oxygen, an outlet for vapour stream (V7) comprising oxygen connected to the inlet for leading vapour stream comprising oxygen into the nitrogen oxide absorption zone (D), and an outlet for a liquid stream (L5) comprising process liquid and nitric acid (formed in zones C, D), which outlet is connected to an inlet for a hydroxyl ammonium salt synthesis zone of the hydroxylamine phosphate oxime process (F).

10. Installation according to claim 9, wherein downstream of the ammonia combustion zone (A)—with respect to the direction of vapour stream—and upstream of ammonium combustion zone (C)—with respect to the direction of vapour stream—a condenser (B) is arranged to condense at least part of the vapour stream leaving ammonia combustion zone (A) via outlet (V3), the condenser (B) further comprising an outlet (V4) for vapour comprising nitrogen oxide (V4) connected to the inlet for vapour stream of ammonium combustion zone (C) and an outlet for liquid (L1) connected to an inlet for liquid acid stream of bleaching zone (E).

11. Use of an installation according to claim 9 for the destruction of ammonium formed in a hydroxylamine phosphate oxime process.
